(19) United States
(12) Patent Application Publication
(10) Pub. No.: US 2005/0144076 A1
(43) Pub. Date: Jun. 30, 2005

(54) Universal consumer offer card

(76) Inventor: Deirdre M. Cimino, Chester Springs, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 11/006,011

(22) Filed: Dec. 7, 2004

Related U.S. Application Data
(60) Provisional application No. 60/532,276, filed on Dec. 23, 2003.

(51) Int. Cl. G06F 17/60

(52) U.S. Cl. 705/14

(57) ABSTRACT

A Universal Offer Health Card (UCOC) that simplifies the consumers' lives utilizing RFID technology and a card having RFID-compatible hardware including a rewriteable medium.

### CROSS-REFERENCE TO RELATED APPLICATION

This application claims priority to and benefit of U.S. provisional application No. 60/532,276, filed Dec. 23, 2003, the disclosure of which is incorporated herein by reference.

### BACKGROUND OF THE INVENTION

The invention disclosed herein relates generally to a universal consumer offer card. More specifically, embodiments of the present invention relate to the encoding and use of the universal consumer offer card with RFID technology. In some aspects, RFID is used with a rewriteable universal consumer offer card to dynamically store coupons.

Savings cards are often used at checkout at a specific grocery store. These savings cards are vendor-specific (e.g. specific to one of Genuardis, Clemens, A&P, Shop Rite, etc.), and the user of the savings card must usually be a member of a “club” associated with the particular vendor. Coupons are also used by consumers to save money on purchases, however consumer need to clip these coupons. Thus, to maximize savings, consumers must carry multiple cards for multiple vendors, in addition to clipping and carrying any coupons.

What is needed in the art is a single savings card that can be simultaneously used with multiple vendors. Furthermore, what is needed is a universal consumer card that can be updated with new coupons and savings on a dynamic basis.

### THE INVENTION

Disclosed herein is a Universal Offer Health Card (UCOC) that simplifies the consumers' lives utilizing RFID technology and a card having RFID-compatible hardware including a rewriteable medium. Preferred embodiments of the UCOC relate comprise a universal consumer offer health card, being primarily related to healthcare and other industries. The UCOC is preferably utilized to consolidate vendor cards in various types of industries, including by way of nonlimiting example, the pharmaceutical, healthcare, luxury goods, electronics, and grocery industries. The UCOC is preferably suitable for application in any industry for which consumer coupons are a viable business model.

The Universal Consumer Offer Card (UCOC) is preferably a standard-sized polymer card sized to fit in a wallet and/or a reduced-sized polymer card sized to be attached to a key chain so as to be noncumbersome. The UCOC is preferably encoded with a single identification code associated with the authorized user of the UCOC (“the consumer”). The identification code is preferably encoded in one or more of a plurality of formats, including by way of nonlimiting example, a bar code, a magnetic strip, radio frequency identification, visually perceptible alphanumeric characters, and other suitable formats. The preferred format is radio frequency identification technology (RFID).

A management web site is provided for management of a single-source account from a home computer on a network (e.g. the Internet). Multiple vendor cards and/or accounts are preferably consolidated into the single-source account for centralized management web site. RFID hardware (e.g. transceiver, antenna, etc.) is provided so that the consumer can wirelessly transfer coupons from the web site on to the UCOC for storage and subsequent redemption at a participating vendor. Thus, in preferred embodiments, a consumer can register various vendor cards through their single-source account that they created on the Internet and then load coupons electronically onto their UCOC, via a single source account.

In preferred embodiments, when consumers load coupons onto their account, the vendors find out what consumers are interested in, as well as what coupons actually get used. Vendors thus get data which can point to product synergies, while consumers get the benefit of consolidating accounts, coupons, cards, etc. and maximizing savings.

In preferred embodiments, a consumer has a single source account associated with the card and vendors have access to consumer demographic information, thereby providing better marketing information to the vendors. Vendors have access to consumer demographic, which is obtained when the consumer creates their single source account and receives the UCOC. Vendors find out where consumers buy their products and register coupons through single business entity, tying offers, memberships (e.g. grocery shoppers club) and discounts accessible through the card account.

The UCOC provides consumers access to offers other than bar code based, as vendors move towards magnetic media and radio frequency identification technology (RFID). RFID refers to a technology that incorporates the use of electromagnetic and/or electrostatic coupling to tag an object and uniquely identify the tagged object (e.g. a tagged person, a tagged thing, etc.). One of the advantages of RFID is that it does not require direct contact or line-of-sight scanning. Radio frequency waves, for example, are preferably utilized to activate a transponder contained within the card. An RFID system of any suitable frequency range is preferred, however a low-frequency RFID system is preferred due to its lower cost and shorter transmission ranges.

In preferred embodiments, coupon information can also be readably and rewriteably stored on the card. The coupons are downloaded from the management web site or another web site. RFID is then used to transfer the coupon information from the home computer to the card.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A universal consumer offer card system, comprising:
a consumer card comprising a transponder tag;
a consumer identification code stored in the transponder tag; and
a plurality of vendor identification codes stored in the transponder tag.

2. The system of claim 1, wherein the transponder tag comprises a programmable transponder tag

3. The system of claim 1, wherein the transponder tag comprises a rewriteable transponder tag

4. The system of claim 1, comprising a plurality of coupons stored in the transponder.

5. The system of claim 1, comprising a transceiver for activating the transponder and receiving from the transponder the consumer identification code and at least one of the plurality of vendor identification codes.

6. A method of using a universal consumer offer card system, comprising:
receiving a plurality of vendor accounts, each of the plurality of vendor accounts being associated with a discount offer;
receiving a plurality of vendor identification codes, each associated with one of the plurality of vendor accounts;
consolidating the plurality of vendor accounts into a consolidated account receiving a consumer identification code associated with a consumer; and
utilizing RFID technology to store on a consumer card the identification code and the plurality of vendor identification codes;
utilizing RFID technology to make a purchase from one of the vendors using the consumer card, said purchase being made against the consolidated account.

7. A method for targeted education and advertising, comprising:
hosting a health-related newsletter template;
receiving consumer information from a consumer at a host computer system designated by a URL, the URL being displayed at a medical facility in association with health-related advertising information;
receiving a code at the host computer system, the code being displayed at the medical facility in association with the health-related advertising information;
populating the health-related newsletter template with health-related newsletter content selected in accordance with the code to create a health-related newsletter;
communicating the health-related newsletter to the consumer; and
communicating the consumer information to an advertiser associated with the health-related advertising information;

8. The method of claim 7, further comprising:
receiving a vendor account associated with the advertiser and a discount offer;
receiving a vendor identification code associated with the vendor account;
receiving a consumer identification code associated with the consumer;
utilizing RFID technology to store on a consumer card the identification code and the vendor identification code; and
utilizing RFID technology to make a purchase from one of the vendors using the consumer card, said purchase being made against the consolidated account.
